(19) United States
(12) Patent Application Publication
(10) Pub. No.: US 2008/0082231 A1
(43) Pub. Date: Apr. 3, 2008

(54) Data setting change apparatus, navigation apparatus and data setting change system

(75) Inventor: Masamitsu Okabe, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/902,796

(22) Filed: Sep. 25, 2007

(30) Foreign Application Priority Data
Oct. 3, 2006 (JP) 2006-271820

(51) Int. Cl. G06F 9/44; G01C 21/26; G06F 19/00

(52) U.S. Cl. 701/35; 701/208

(57) ABSTRACT

A car navigation apparatus determines whether a setting change of control data in an electronic controlling unit interfere with driving condition of a vehicle when an instruction for setting change is inputted from an occupant of the vehicle. The setting change of the control data is performed when the setting change is determined not to interfere with the driving condition. In this manner, an uncomfortable feeling of the occupant of the vehicle due to the setting change of the control data is prevented from occurring. That is, the setting change of the control data is performed at an appropriate timing to avoid an interference with the driving condition of the vehicle.

### CROSS REFERENCE TO RELATED APPLICATION

This application is based on and claims the benefit of priority of Japanese Patent Application No. 2006-271820 filed on Oct. 3, 2006, the disclosure of which is incorporated herein by reference.

### FIELD OF THE DISCLOSURE

The present disclosure generally relates to a system and apparatus for controlling data setting of an electronic controlling unit for use in a vehicle.

### BACKGROUND INFORMATION

The conventional car navigation apparatuses have a hands-free function that allows a driver or occupant to operate the apparatus by using a voice, and a destination of a travel or the like is specified by using the voice of the driver or the occupant through the hands-free function while the vehicle is traveling (refer to Japanese Patent Document JP-A-2004-333319).

The automotive vehicle is usually equipped on its body electronic devices such as a power window actuator for operating a window, a wiper actuator for operating a wiper and the like. These electronic devices are controlled by an electronic controlling unit (ECU) on the vehicle. In addition, the ECU stores control data for controlling these electronic devices. The control data is, for example, power window open/close speed data, wiper operation speed data and the like.

An inventor considered to add a function that allows the driver or the like to perform setting change of the control data in the ECU for an improved convenience.

If the function for changing the control data in the ECU under control of the occupant of the vehicle is added to the disclosure in the above patent document, the occupant of the vehicle is enabled to perform the setting change of the control data while the vehicle is traveling, due to an enablement of the operation of the navigation system by the occupant of the vehicle in the traveling vehicle.

Then, the change of the control data in the traveling vehicle may result in, for example, a recognizable change of operation condition such as the power window open/close speed change or the wiper operation speed change, thereby causes an uncomfortable feeling for the driver or the like and may interfere with the driving operation of the vehicle.

### SUMMARY OF THE DISCLOSURE

In view of the above and other problems, the present disclosure provides a data setting change apparatus and system that performs the data setting change at an appropriate timing in terms of control data to be used to control an electronic controlling unit in a vehicle.

The data setting change apparatus of the present disclosure includes an interference determination unit that determines an interference between data setting change upon having an input of a data change instruction for changing the data setting of the control data and a driving condition of the vehicle, and a setting change unit that performs the data setting change of the control data upon having a determination by the interference determination unit that there is no interference between the data setting change and the driving condition of the vehicle. The data setting change apparatus of the present disclosure is used for performing data setting change of the control data that controls an electronic device in the vehicle, and the setting of the control data is changed when the data setting change of the control data does not interfere with, or affect, the driving condition of the vehicle.

The data setting change apparatus performs the data setting change by using the setting change unit when the setting change does not affect the driving condition, thereby preventing an uncomfortable feeling to be sensed by a driver of the vehicle.

Therefore, in other words, the control data of the electronic controlling unit is changed at an appropriate timing in terms of an interference with the driving condition of the vehicle.

Further, the above apparatus may be implemented as a car navigation apparatus by including the function of the data setting change apparatus and a display unit.

That is, the navigation apparatus changes the setting of the control data at an appropriate timing as the data setting change apparatus.

Furthermore, the above apparatus may be implemented as a data setting change system by including the function of the data setting change apparatus and a data transmitter for transmitting the control data for setting change.

In this manner, the data setting change system is capable of changing the setting of the control data at an appropriate timing.

### BRIEF DESCRIPTION OF THE DRAWINGS

Other objects, features and advantages of the present invention will become more apparent from the following detailed description made with reference to the accompanying drawings, in which:

FIG. 1 shows a block diagram of a navigation system in an embodiment of the present disclosure;

FIG. 2 shows a block diagram of an information center terminal in the embodiment of the present disclosure;

FIG. 3 shows a flowchart of a process in a control unit of the information center terminal in the embodiment of the present disclosure; and

FIG. 4 shows a flowchart of a control data setting change process in a control unit of the navigation system in the embodiment of the present disclosure.

### DETAILED DESCRIPTION

An embodiment of the present disclosure is explained in the following with drawings.

1. An Entire Configuration of a Car Navigation System

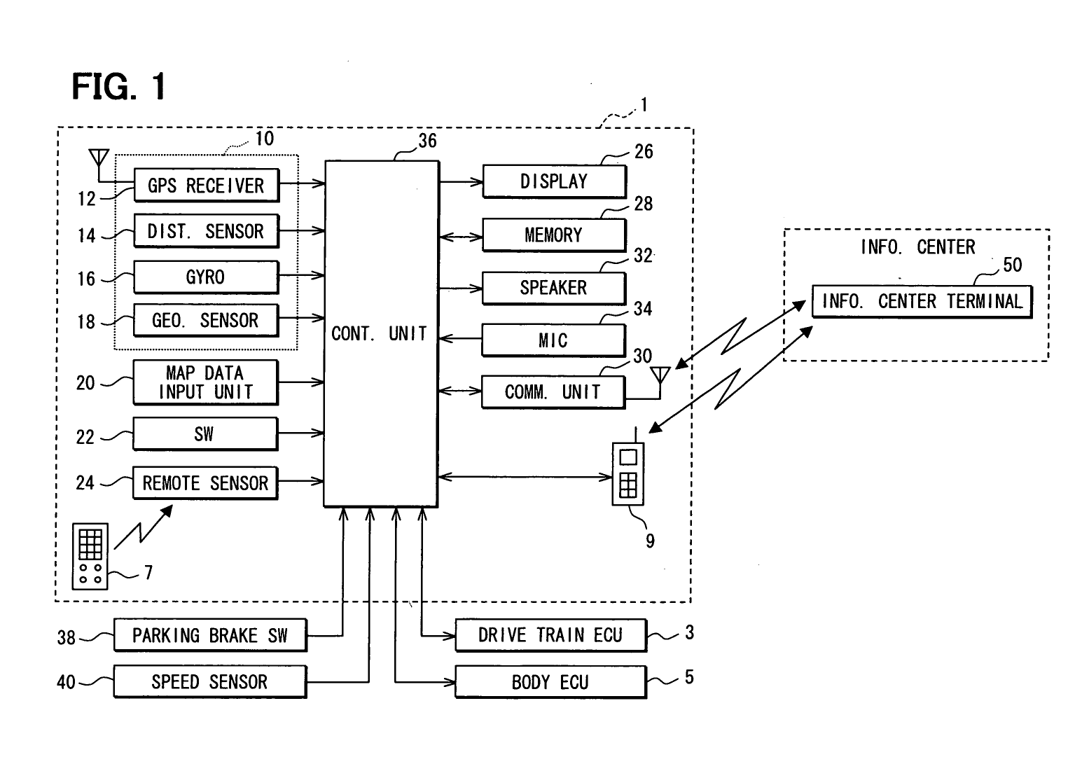

FIG. 1 shows a block diagram of a car navigation system that is explained the present embodiment.

The car navigation system includes a car navigation apparatus 1 carried by a vehicle (not shown in the figure) and an information center terminal 50 which is placed at an outside of the vehicle for performing radio communication with the car navigation apparatus 1.

2. Car Navigation Apparatus 1 (Refer to FIG. 1)

The car navigation apparatus 1 has functions such as displaying a current position moving along a travel of the vehicle with a road map on a display screen, guiding a path from the current position to a destination which an occupant of the vehicle has set, and the like.

Further, the car navigation apparatus 1 of the present embodiment has a function for performing setting change of control data that controls vehicular electronic devices by using a drive train ECU (an electronic control unit) 3 and a body ECU 5 mounted on the vehicle.

In this case, the driver train ECU 3 is a device for controlling vehicle driving mechanisms such as an engine, a brake, a steering device and the like (not shown in the figure), and this ECU 3 controls a driving condition of the vehicle by controlling the electronic devices in the engine, the brake, and the steering device.

The body ECU 5 is a device for controlling the electronic devices attached to a body of the vehicle, and this ECU 5 performs power window open/close control, wiper actuation control, seat movement control, headlamp lighting control, room lamp lighting control and the like by controlling the electronic devices attached on a body of the vehicle.

The car navigation apparatus 1, as shown in FIG. 1, includes a position detector 10, a map data input unit 20, operation switches 22, a remote sensor 24, a display unit 26, an external memory 28, a vehicular communication unit 30, a speaker 32, a microphone 34, a control unit 36 and the like.

2.1. Position Detector 10

The position detector 10 s used for detecting a current position of the vehicle, and includes a global positioning system (GPS) receiver 12 which receives radio wave from a satellite through a GPS antenna for detecting the current position of the vehicle, a distance sensor 14, a gyroscope 16 and a geomagnetism sensor for detecting an absolute direction based on geomagnetism.

Then, the position detector 10 is configured to function by using respective sensors 12, 14, 16, 18 in a mutually compensating manner due to different natures of errors inherent in each of the sensors 12, 14, 16, 18. In addition, the position detector 10 may be configured to use some of those sensors 12, 14, 16, 18 depending on the accuracy, and may also use a steering rotation sensors, a tire sensor on each tire or the like.

2.2. Map Data Input Unit 20

The map data input unit 20 reads out map data from a storage medium that is not illustrated, and inputs the data read out to the control unit 36. In the storage medium, data representing connections of a road (link data and node data), topography data, facility data and the like are stored as map data, as well as map matching data for an improvement of position detection accuracy audio data for route guidance and the like.

In addition, the storage medium generally is a compact disk read only memory (CD-ROM) and a DVD due to an amount of data to be stored. However, the storage medium may be other type of devices such as a hard disk a memory card or the like.

2.3. Operation Switches 22

Operation switches 22 are operated by occupants of the vehicle for inputting various instructions to car navigation apparatus 1. The operation switches 22 are integrally formed with the display unit 26 as touch switches on a display screen, and/or mechanical key switches around the display screen and the like.

2.4. Remote Sensor 24

The remote sensor 24 is a device for inputting signals from a remote controller 7 that has switches and the like for inputting various instructions from the occupants of the vehicle to the car navigation system 1, and is used in the same manner as the operation switches 22 for instruction inputs.

2.5. Display Unit 26

The display unit 26 displays for the occupants of the vehicle road information such as a map including road connection information for a travel of the vehicle and the like. The display unit 26 is controlled by the control unit 36 for the map that includes the vicinity of a vehicle travel route as well as a current vehicle position mark for representing the current position of the vehicle for representing a current position of vehicle is displayed in terms of collar, a warning message for drawing attention of the occupants and the like.

2.6. External Memory 28

The external memory 28 is a non-volatile memory (e. g., an EEPROM) which can retain data even when a supply of electricity is intercepted. The external memory 28 stores various data such as a route setting by the control unit 36 and the like.

2.7. Vehicular Communication Unit 30

The vehicular communication unit 30 is a device for performing radio communication to the information center terminal 50. More practically, the communication unit 30 connects to the information center terminal 50 through a radio station (illustration abbreviated) that is in connection with a telephone network (illustration abbreviated) for performing radio communication.

2.8. Speaker 32 and Microphone 34

The speaker 32 is a device for outputting various guidance that are necessary for the occupant of the vehicle by a sound, and the microphone 34 is a device for inputting a voice of the occupant. In addition, when a driver of the vehicle places a hands-free call (a transmission and reception of voice communication) by using a cellular phone 9 that is connected to the car navigation apparatus 1, the microphone 34 is used to input a voice to be transmitted, and the speaker 32 is used to output a voice on behalf of the cellular phone 9.

2.9. Control Unit 36

The control unit 36 is composed mainly from a microcomputer including a central processing unit (CPU), a RAM, a ROM and the like. The control unit 36 executes each of the programs stored in the ROM or the like for performing each of the functions of the navigation apparatus 1 and for controlling each part of the apparatus 1.

In addition, the control unit 36 displays the current position of the vehicle on top of the map of vehicle vicinity on the display unit 26 while performing general map display process and route guidance process for providing route guidance toward the destination when a destination is specified.

Further, the control unit 36 receives inputs of a parking brake signal from a parking brake switch 38 that detects an operation condition of a parking brake as well as various signals from sensors/switches such as a speed signal from a speed sensor 40 that detects a travel speed of the vehicle. Furthermore, the control unit 36 is connected to the drive train ECU 3 and the body ECU 5 in a communicable manner.

Furthermore, the control unit 36 performs a control data setting change process for changing setting of the control data, which allows the driver train ECU 3 and the body ECU 5 to control each of the electronic device, upon having control data setting change instruction is inputted from the operation switches 22, the remote 7 or the like when the control data setting change does not interfere with the driving condition of the vehicle.

In other words, the control unit 36 performs adjustments of the electronic devices under control of the body ECU 5 and the driver train ECU 3. More practically, a opening/closing speed of the power window, an actuation velocity of the wiper, a seat position, a lighting timing of the headlamp, a room light color/brightness, a braking force, an accelerator opening, a steering angle and the like are adjusted.

3. Information Center Terminal 50

3.1 Configuration of the Information Center Terminal 50

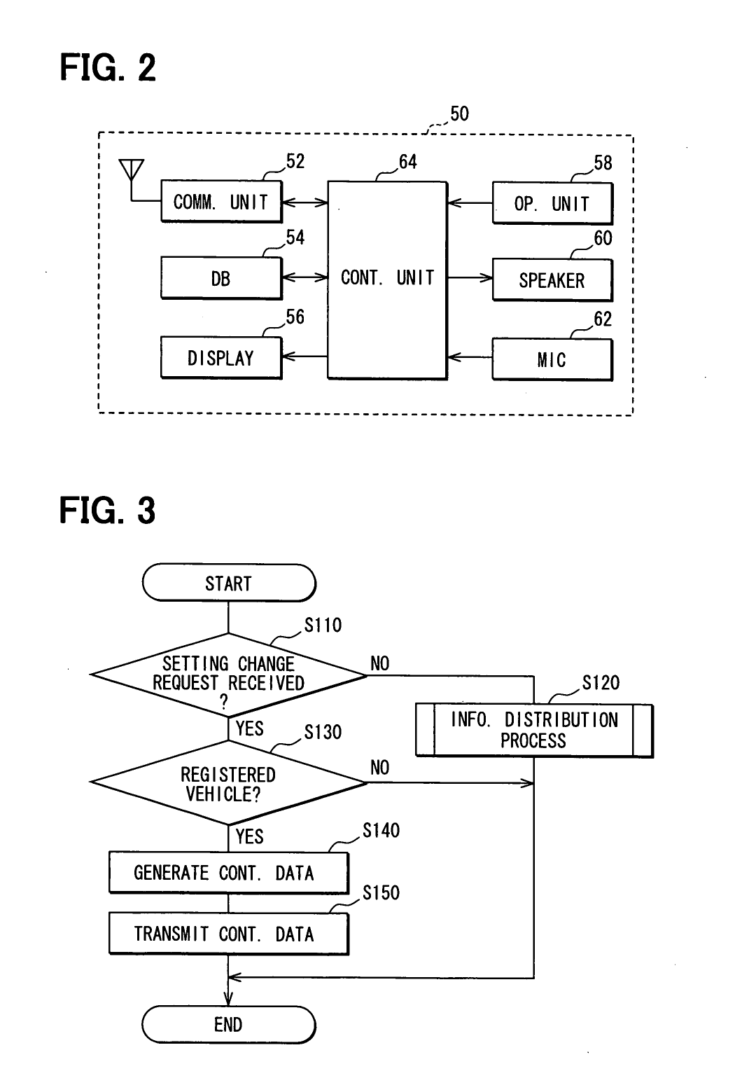

FIG. 2 shows a block diagram of a configuration of the information center terminal 50.

The information center terminal 50 is installed for delivering various information such as traffic information, weather information and the like for the car navigation apparatus 1 (i.e., for a vehicle) as well as for generating and transmitting control data to the car navigation apparatus 1.

The terminal 50 includes, as shown in FIG. 2, a communication unit 52 for communication with the navigation apparatus 1, a database 54 for accumulating various information such as vehicle information that represents vehicles registered by an information center as well as traffic information, weather information and the like, a display unit 56, an operation unit 58 that is operated by an operator of the information center to input various instructions to the terminal 50, a speaker 60, a microphone 62 a control unit 64 for controlling each part of the terminal 50.

3.2 Operation of the Information Center Terminal 50

FIG. 3 shows a flowchart representing a process performed by the control part 64 of the information center terminal 50.

The process in the flowchart (a control flow) in FIG. 3 is started when communication is established between the vehicle (the navigation apparatus 1) and the information center terminal 50 (the communication unit 52) by transmitting various instructions such as control data setting change instruction, traffic information delivery instruction and the like from the vehicle.

When the control flow in FIG. 3 is started, whether the communication unit 52 has received a setting change instruction of the control data from the car navigation apparatus 1 is determined (S110).

Then, when it is determined that the communication unit 52 has not receive the setting change instruction of the control data (S110:NO), information delivery process for the car navigation system 1 (i.e., the vehicle) that the communication has currently been established with is performed for the delivery of the various information such as the vehicle information, the weather information and the like (S120), and the control flow concludes itself.

On the other hand, when it is determined that the communication unit 52 has received the setting change instruction of the control data (S110:YES), whether the vehicle (i.e., the navigation apparatus 1) with which the communication from the communication unit 52 is currently being established is the one that is registered by the information center (S130).

Then, when it is determined that the vehicle currently in communication with the communication unit 52 is not registered in the information center (S130:NO), the control flow concludes itself. On the other hand, when it is determined that the vehicle is determined to be registered in the information center (S130:YES), the control data that corresponds to a control data setting change instruction is generated (S140).

In this case, in the present embodiment, it is configured for the terminal 50 to generate the control data corresponding to the setting change instruction of the control data based on an input of the various information to the terminal 50 through the operation unit 58 by the operator according to the setting change instruction of the control data.

Then, after generating the control data in the process in step S140, the control data which should be used by the vehicle (i.e., the car navigation system 1) currently being in communication for setting change is transmitted to the vehicle (i.e., the car navigation system 1), and the control flow concludes itself.

4. A Characteristic Operation of the Car Navigation System 1 in the Present Embodiment

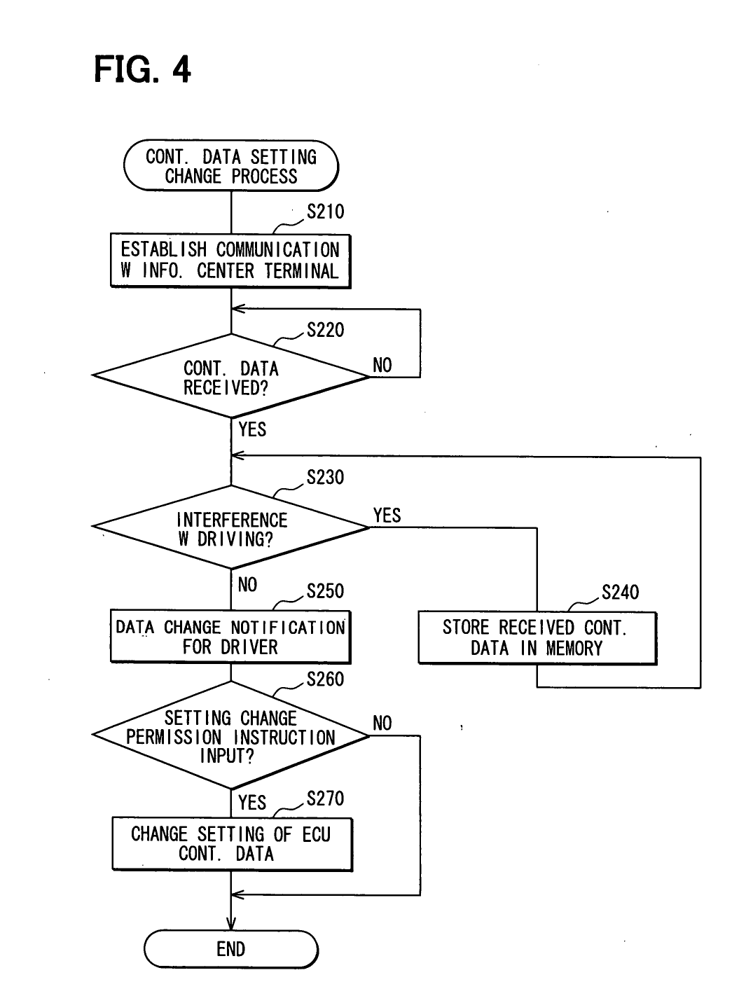

FIG. 4 shows a flowchart representing a control data setting change process that the control unit 36 of the car navigation system 1 carries out.

When the control flow (i.e., the data setting change process) in FIG. 4 is started by an input of the control data setting change instruction to the control unit 36, the radio communication between the communication unit 30 or the cellular phone 9 and the information center terminal 50 is established and, by using the communication unit 30 or the cellular phone 9, the control data setting change instruction is transmitted to the information center terminal 50 (S210).

In this case, when a voice call is placed between the operator of the information center and the occupant of the vehicle, the communication between the cellular phone 9 and the information center terminal 50 is established. When, to the contrary, data communication instead of the voice call is performed, the communication between the communication unit 30 and the information center terminal 50 is established.

Then, when the radio communication between the communication unit 30 or the cellular phone 9 and the information center terminal 50 is established, reception of the control data by the communication unit 30 or the cellular phone 9 from the information center terminal 50 is determined (S220).

Then, when it is determined that the communication unit 30 or the cellular phone 9 has not received the control data (S220:NO), the process in step S220 is repeated until it is determined that the control data is received by the communication unit 30 or the cellular phone 9.

On the other hand, when it is determined that the control data is received by the communication unit 30 or the cellular phone 9 (S220:YES), whether the interference of the setting change of the control data to the driving condition is expected is determined based on a parking brake signal and a vehicle speed signal (S230).

More practically, the process in step S230 determines whether the vehicle is in a parking condition based on the parking brake signal and the vehicle speed signal. Then, when the vehicle is determined not to be in the parking condition (i.e., the vehicle is traveling), the setting change is determined to interfere with the driving condition of the vehicle (S230:YES). On the other hand, when the vehicle is determined to be in the parking condition, the setting change is determined not to interfere with the driving condition of the vehicle (S230:NO).

In this case, the vehicle is determined to be in the parking condition when the vehicle is stopping for a predetermined time (e. g., three minutes) or longer in the present embodiment, and otherwise (i.e., not stopping at least for the predetermined time) the vehicle is determined not to be in the parking condition (i.e., the vehicle is determined to be traveling) .

Then, the setting change of the control data is determined to interfere with the driving condition of the vehicle (S230:YES), the control data received in the process in step S220 is stored to the external memory 28 (S240), and the process returns to step S230.

In other words, when it is determined that the setting change of the control data interfere with the driving condition of the vehicle (S230:YES), the control data received in step S220, that is, the control data to be utilized in the setting change, is stored in the external memory 28 until the setting change is determined not to interfere with the driving condition of the vehicle.

On the other hand, when it is determined that the driving condition of the vehicle is not interfered with the setting change of the control data (S230:NO), the occupant of the vehicle is notified that the setting change of the control data is allowed by displaying on the display unit 26 an image that expresses that the setting change of the control data is allowed (S250).

Then, when the notification that the setting change of the control data is allowed has been provided for the occupant of the vehicle in the process in step S250, it is determined whether a setting change permission instruction that represents a permission of the setting change of the control data is input from the remote controller 7 or the operation switches 22(S260).

Then, when it is determined that the setting change permission instruction has not been input (S260:NO), the control flow is concluded. When, conversely, it is determined that the setting change permission instruction has been input (S260:YES), the control data before change is changed to the control data received in the process is step S220 or the control data stored in the external memory 28 (S270), and the control flow concludes itself.

In this case, when the setting change of the control data is performed (S270), the control data used in a current setting change is deleted from the control data stored in the external memory 28.

In addition, among the control data received in the process in step S220 or stored in the external memory 28, the control data that is not used in the current setting change is stored in the external memory 28 and is notified again in the process in step S250 when the control data setting change process is started subsequently. Further, the occupant of the vehicle can, by an operation, delete the control data that is stored in the external memory 28.

5. Advantage of the Car Navigation System in the Present Embodiment

In the present embodiment, the setting change of the control data is performed when it is determined not to cause an interference to the driving condition of a vehicle (S230:NO), thereby preventing the setting change from causing an uncomfortable feeling to a driver of the vehicle.

In other words, the setting change is performed at an appropriate timing in terms of the driving condition of the vehicle. In addition, the control data for the setting change is stored in the memory for later use even when the setting change is not performed at the time of the reception of the control data, thereby saving a re-input of setting change instruction for use of the control data at an appropriate time or the like.

By performing the setting change during a parking time, causing the uncomfortable feeling of the driver of the vehicle is securely prevented.

By defining that the setting change during a travel of the vehicle interferes with the driving condition of the vehicle, the setting change during the travel of the vehicle is securely prevented.

By employing plural detection units such as the speed sensor 40 and the parking brake switch 38 for detecting the vehicle condition, the accuracy of the detection result (S230) is improved, and thus the setting change during at the appropriate timing is secured.

Although the present invention has been fully described in connection with the preferred embodiment thereof with reference to the accompanying drawings, it is to be noted that various changes and modifications will become apparent to those skilled in the art.

In the embodiment described above, a parking brake signal and a speed signal are used to determine whether the vehicle is in the parking condition (refer to S230 in FIG. 4). However, the current position of the vehicle from the position detector 10 may be used to determine whether the vehicle is parking.

That is, in step S230, when the current position of the vehicle from the detector 10 is in a parking space and the vehicle is stopping for a predetermined time (e. g. 20 minutes) or more, the vehicle is determined to be parked and the setting change of the control data is determined not to interfere with the driving condition of the vehicle.

In this manner, the setting change of the control data is also performed at an appropriate timing.

In addition, when the communication is established between the information center terminal 50 and the car navigation system 1, Bluetooth function (registered trademark) of a cellular phone may be used instead of using a dedicated communication unit.

Further, the control data setting change process (FIG. 4) may be performed by a device other than the navigation apparatus 1 as described in the above embodiment.

Furthermore, the control data to be used in the setting change may be generated by a device other than the information center terminal 50. The control data may be, for example, generated by the navigation apparatus 1.

Furthermore, the setting change may be determined not to interfere with the driving condition of the vehicle that is temporarily stopping, instead of determining that the vehicle in the parking condition is not interfered with the setting change.

Such changes and modifications are to be understood as being within the scope of the present invention as defined by the appended claims.

What is claimed is:

1. A data setting change apparatus for changing data setting of control data of an electronic controlling unit that controls electronic device in a vehicle, the apparatus comprising:
an interference determination unit that determines an interference between data setting change upon having an input of a data change instruction for changing the data setting of the control data and a driving condition of the vehicle; and
a setting change unit that performs the data setting change of the control data upon having a determination by the interference determination unit that there is no interference between the data setting change and the driving condition of the vehicle.

2. The data setting change apparatus of claim 1 further comprising:
a storage unit that stores the control data to be used in the data setting change by the setting change unit until the determination by the interference determination unit changes from existence of the interference to no interference when the interference determination unit has originally determined that there is the interference between the data setting change and the driving condition,
wherein the setting change unit performs the data setting change to change the control data before change to the control data stored in the storage unit when the interference determination unit has determined that there is no interference between the data setting change and the driving condition of the vehicle.

3. The data setting change apparatus of claim 1,
wherein the interference determination unit determines whether or not the vehicle is parked, and
the interference determination unit determines that there is no interference between the data setting change and he driving condition when the vehicle is determined to in a condition of being parked.

4. The data setting change apparatus of claim 3,
wherein the interference determination unit determines whether or not the vehicle has been parked for a time that is equal to or greater than a predetermined period, and
the interference determination unit determines that the vehicle is in a condition of being parked when the vehicle has been parked for the time that is equal to or greater than the predetermined period.

5. The data setting change apparatus of claim 4,
wherein the interference determination unit determines whether or not the vehicle is traveling, and
the interference determination unit determines that there is the interference when the vehicle is determined to be traveling.

6. The data setting change apparatus of claim 5 further comprising:
a speed detector that detects a traveling speed of the vehicle,
wherein the interference determination unit determines the existence of the interference based on a detection result of the speed detector.

7. The data setting change apparatus of claim 5 further comprising:
a brake condition detection unit that detects a parking brake condition of the vehicle,
wherein the interference determination unit determines the existence of the interference based on a detection result of the brake condition detection unit.

8. The data setting change apparatus of claim 5 further comprising:
a current position detection unit that detects a current position of the vehicle,
wherein the interference determination unit determines the existence of the interference based on a detection result of the current position detection unit.

9. The data setting change apparatus of claim 1 further comprising:
a reception unit that receives the control data to be used by the setting change unit from an external resource,
wherein the setting change unit performs the data setting change by changing the control data before change to the control data received by the reception unit when the interference determination unit has determined that there is no interference between the data setting change and the driving condition of the vehicle.

10. A navigation apparatus having the data setting change apparatus of claim 1, the apparatus at least comprising:
a display unit that displays road information.

11. A data setting change system having the data setting change apparatus of claim 9, the system comprising:
a control data transmission unit that is disposed externally relative to the vehicle for transmitting to the reception unit the control data to be used in the data setting change performed by the setting change unit.
